(19) United States
(12) Patent Application Publication
(10) Pub. No.: US 2019/0109782 A1
(43) Pub. Date: Apr. 11, 2019

(54) ARCHITECTURE FOR LOW OVERHEAD CUSTOMIZABLE ROUTING WITH PLUGGABLE COMPONENTS

(71) Applicant: Vatsal Shah, San Jose, CA (US)

(72) Inventors: Vatsal Shah, San Jose, CA (US); Ashish Tanwer, Sunnyvale, CA (US); Atishay Jain, Sunnyvale, CA (US)

(73) Assignee: Litmus Automation Inc., San Jose, CA (US)

(21) Appl. No.: 16/213,567

(22) Filed: Dec. 7, 2018

(51) Int. Cl. H04L 12/707; H04L 29/08; H04L 12/781

(52) U.S. Cl. CPC H04L 45/22; H04L 45/52; H04L 69/329

(57) ABSTRACT

The patent describes the embodiment of system and methods of a modular IOT enabled router with user controllable and pluggable modules. The architecture of the router and plugins allow users to install packet level and application level modules at real-time without affecting the latency and router performance. The installed modules are executed in parallel in their own executing unit and in the predefined or user-specified order. The leveled architecture allows fine-grain control of the routing and forwarding internals like QOS, deep packet inspection, encryption, traffic flow control, and traffic filtering via packet level modules. At the same time, it allows running service like a proxy, firewall, web acceleration, ad-blocking via application level modules. The full control provides an easy interface for a developer to write plugins for new protocols, SDN, IOT, and user applications and run them in separate controlled execution engine without affecting the core router engine that is running security.

### REFERENCES

| | | |
|---|---|---|
| Apr. 18, 2000 | U.S. Pat. No. 6,052,695A | Abe, Kenichi; Imafuku, Yukiharu; Kirita, Hitoshi; Inoue, Toshiyuki; |
| | | Takahashi, Hiroaki; Shigehata, Yoji; Konno, Yuichi; Narata, Kazuaki; |
| | | Odanaka, Tadao |
| Jan. 8, 2013 | U.S. Pat. No. 8,352,941B1 | Protopopov, Boris; Leschner, Jurgen |
| Sep. 27, 2016 | U.S. Pat. No. 9,454,318B2 | Zhu, Ming Benjamin; Patterson, R. Hugo; Li, Kai |
| Jun. 28, 1971 | U.S. Pat. No. 3,587,387A | Burrows, Milford D.; Quedens, Phillipp J. |
| Apr. 11, 2000 | U.S. Pat. No. 6,049,524A | Fukushima, Hidehiro; Tsukakoshi, Masato; Morimoto, Shigeki; Setoyama, |
| | | Tohru |
| Dec. 28, 1999 | U.S. Pat. No. 6,009,081A | Wheeler, Christopher D.; Ronen, Ophir |
| May 1, 2001 | U.S. Pat. No. 6,226,684B1 | Sung, Yi-Hsin; Dayal, Vibha; Ramakrishnan, Satish |
| Oct. 5, 1999 | U.S. Pat. No. 5,963,540A | Bhaskaran, Sajit |
| Dec. 16, 2008 | U.S. Pat. No. 7,466,703B1 | Arunachalam, Raman; Kumar, Vijay P.; Rathnavelu, Sunder R.; Stiliadis, |
| | | Dimitrios; Tzeng, Hong-Yi |
| Dec. 18, 2007 | U.S. Pat. No. 7,310,344B1 | Sue, John Ah |
| May 26, 2011 | US20110122810A1 | Hodroj, Samir M.; Hassan, Omar |
| Nov. 5, 1996 | U.S. Pat. No. 5,572,528A | Shuen, Pauline |
| Nov. 13, 2012 | U.S. Pat. No. 8,310,335B2 | SIVAKKOLUNDHU, Premanand X. |
| Aug. 16, 2005 | U.S. Pat. No. 6,931,018B1 | Fisher, Gregory S. |
| Jun. 26, 2003 | US20030117965A1 | Markki, Outi; Kniveton, Timothy; Malinen, Jari; Devarapalli, Vijay; |
| | | Perkins, Charles |
| Jul. 29, 2010 | US20100188971A1 | Chiang, Mung |
| Oct. 14, 2010 | US20100262467A1 | JR, John A. Barnhill; Banks, Alan Drew |
| Sep. 11, 2014 | US20140259147A1 | L'Heureux, Israel; Alleman, Mark |
| May 21, 2009 | US20090132698A1 | JR, John A. Barnhill |
| Jan. 1, 2009 | US20090003269A1 | Kumazawa, Masayuki; Matsumoto, Taisuke |
| Jul. 28, 2011 | US20110182227A1 | Rune, Johan |
| Dec. 1, 2005 | US20050265323A1 | Thermond, Jeffrey |
| May 5, 2011 | US20110103284A1 | Gundavelli, Srinath; Choudhury, Abhijit; Suri, Rohit; Kanagasabapathy, |
| | | Venkatesh; Nelakanti, Bhavannarayana; Jain, Sudhir |
| Feb. 26, 2009 | US20090052416A1 | Kumazawa, Masayuki; Matsumoto, Taisuke |

### OTHER PUBLICATIONS

[1] “About|Asuswrt-Merlin.” [Online]. Available: https://asuswrt.lostrealm.ca/about.

[2] “Welcome to the Tomato USB website—Tomato USB.” [Online]. Available: http://tomatousb.org/.

[3] http://prahec.com, “Advanced Tomato: Downloads,” Advanced Tomato. [Online]. Available: https://advancedtomato.com//downloads.

[4] http://prahec.com, “Advanced Tomato: Open Source Broadcom Firmware,” Advanced Tomato. [Online]. Available: https://advancedtomato.com//

[5] “ASUSWRT,” ASUS Global. [Online]. Available: https://www.asus.com/ASUSWRT/.

[6] E. Sauvageau, asuswrt-merlin: Enhanced version of Asus's router firmware (Asuswrt) (legacy code base). 2018.

[7] “Best DD-WRT Router 2018 Reviews—Ultimate Buyer's Guide,” Top 10 Tech Product Reviews—Tenwitch, 3-May-2018.

[8] “Buffalo Technology—Press—Press Releases—Buffalo Partners with New Media-NET,” 16-Jan.-2008. [Online]. Available: https://web.archive.org/web/20080116185127/http://www.buffalo-technology.com/press/releases/buffalo-partners-with-newmedia-net/.

[9] “DD-WRT,” Wikipedia. 3-May-2018.

[10] “DD-WRT» About.” [Online]. Available: https://dd-wrt.com/about/.

[11] “DD-WRT Forum: View topic—Congratulations on the partnership w/Buffalo!” [Online]. Available: https://forum.dd-wrt.com/phpBB2/viewtopic.php?p=121822&highlight=#121822.

[12] S. J. Vaughan-Nichols, “DD-WRT Linux firmware comes to Linksys routers,” ZDNet. [Online]. Available: https://www.zdnet.com/article/dd-wrt-linux-firmware-comes-to-linksys-routers/.

[13] “El baul de Victek, Tomato RAF, Router, NocatSplash, Captive Portal, Bricked Router Recovery Tools.” [Online]. Available: http://victek.is-a-geek.com/.

[14] “Firmware Mod Kit—Modify the Files in Firmware Binaries!” [Online]. Available: https://bitsum.com//firmware_mod_kit.htm.

[15] “Google Code Archive—Long-term storage for Google Code Project Hosting.” [Online]. Available: https://code.google.com/archive/p/tomato-sdhc-vlan/.

[16] B. Dumitru, “How to Install the Tomato Custom Firmware on an ASUS RT-N53 Router,” Softpedia. [Online]. Available: http://news.softpedia.com/news/How-to-Install-the-Tomato-Custom-Firmware-on-an-ASUS-RT-N53-Router-457324.shtml.

[17] “How to Set Up VPN on a DD-WRT Router,” Best-VPN.net, 10-Jan.-2017.

[18] “kille72/fresh tomato-arm.” [Online]. Available: https://bitbucket.org/kille72/freshtomato-arm.

[19] “Known incompatible devices—DD-WRT Wiki.” [Online]. Available: https://wiki.dd-wrt.com/wiki/index.php/Known_incompatible_devices.

[20] “Mods—Tomato USB.” [Online]. Available: http://tomatousb.org/mods.

[21] “Tomato (firmware)—Wikipedia.” [Online]. Available: https://en.wikipedia.org/wiki/Tomato_(firmware).

[25] “Tomato Firmware—Browse/tomato/1_28 at SourceForge.net.” [Online]. Available: https://sourceforge.net/projects/tomatofirmware/files/tomato/1_28/.

[26] “Tomato Firmware 1 Polarcloud.com.” [Online]. Available: http://www.polarcloud.com/tomato.

### BACKGROUND

Transfer of data involves control of flow at points of intersection where decisions are made that profoundly impact the prioritization, the performance and even the delivery of the items in transit. An imperfect control flow can lead to congestion, delays, and losses. Therefore, most flow control systems are built with a hard-coded set of rules that everyone follows. These rules are mostly static and once defined they rarely change and cannot be controlled externally. In the world of circuit or packet switching these rules are built into hardware that the device which performs these activities called the router follows and forces the network to follow as well. A well-tuned set of rules are built into the router with little user control and while the router designers are expert at general considerations, case specific overrides and optimizations are not possible with the hard-coded design. The router does offer some customization options and the ability to add items to the routing table, but router design in monolithic that is, changing one part of the routing infrastructure requires a new version of firmware with a different hard-coded set of states that are followed after its installation.

Routers work in the environment of trust where everything is trusted by default and resources are spent identifying untrustworthy data. A router has a built-in support for filtering untrustworthy data and the quality of service (QoS) rules are also predefined. These rules cannot adapt based on usage or user control. Most routing systems are closed systems where the end user cannot add custom filter rules to the system. These systems are not friendly to research and innovation and third parties cannot extend the router by adding their own logic to define the routing process. This cause overrides to be done via a software stack that resides outside of the core router.

The router in these cases is converted to a dumb device where it connects over to a virtual private network or a to a proxy server that does the real routing for the end user.

Both these limitations have a profound impact on the router performance, the feature set and customizability for the end user. These limitations multiply in the case of sensor networks where the sensors and in many cases are low CPU and low power devices and it is not practical to have another device to perform the real routing. In such networks, the manufacturers are forced to design multiple hard-coded routers that are sold separately where the user is forced to buy a set up a new device for changes to the configuration. Even in regular commercial or personal networks, the overhead of a new device to perform customizations over the routing behavior are prohibitively expensive and are not employed in many places.

### SUMMARY

This summary is provided to introduce the key concepts and components of the system in a simplified form which are extensively described in the detailed description section. This does not identify the key features claimed in the subject matter and should be used for understanding the concept in general. This patent provides a method to enable finer control of the inner routing mechanics to the end user without impacting the performance of the system. The claim is not limited to the routing of packets in a computer network though it has been illustrated by the flow of data through the routing application where the user can plug in components to customize the routing engine based on the environment and the user needs. This allows the user to tune the network for software-defined networking, virtualization and also in research and development of new routing technology. We break the monolithic router design into a pluggable apparatus that can be dynamically updated without having a significant impact on the overall system stability or performance.

Such a system can cope up with harsh environmental conditions as well as untrustworthy downstream or upstream sources. For an untrustworthy upstream connection, a secure encrypted gateway is established between the router and the server thereby delegating the performance overhead from the clients onto the router by establishing a Virtual Private Network (VPN). This is essential in low powered sensor networks where the individual sensors lack the processing and battery capacity to perform such an action. The router in these cases not only acts as the aggregator but also the performs the tasks of upstream prioritization, ensuring the smooth connectivity. Establishing VPNs is very different from traditional general-purpose routing in the case of low power sensor networks and therefore a pluggable model is essential to have an optimized connection for the specific case. The patent provides such an extensible architecture without major overhead for having such a system.

In the downstream network, there are multiple cases of interference especially in cases of wireless connectivity and those interferences can lead to denial of service (DOS) for specific end nodes in the network. The routing system provides support for filtering and monitoring traffic with full control of the user optimizing for the end user's reporting requirements rather than overall throughput.

Such a system can be used in industrial as well as IOT applications. In industrial networks, the downstream filtering an interference is caused by a variety of electromagnetic interference in the network. The upstream optimization is needed for optimizing the battery life of the router as well as the end nodes. In IOT environment, the downstream optimizations and filtering are required for preventing rogue clients as well as rogue requests from identified secure clients like malware, ads or other unwanted bandwidth consumers that the end user wants to block. The upstream prioritization and security are required for flow control, quality of service enforcement as well as to prevent deep packet inspection, piggy bagging and to identify and monitor throttling by the upstream network.

In accordance with the aspects of the present disclosure, data is received by the routing system is placed onto the data queue after verification of the OSI Layer 1 and Layer 2 correctness of the data. From the data queue packets are inspected one by one in parallel by a set of execution instances that filter out the incorrect packets to the root router that passes them onto a series of prioritized modules specified by the user—the Modifications, the Traffic Measurement, the rejecters, the forwarders and finally the default hardcoded routing layer. The bypass and debugging modes are hard coded in the root router. The execution instances run in the user mode and are configurable and updatable by the user independently and can be plugged into the system at will. These modules can be made available via a package manager or an application store that the users can access to download module/apps as well as build and submit their own modules to it.

### BRIEF DESCRIPTION OF THE DRAWINGS

The present invention is described in detail below with references to the following images where

FIG. 1 describes the high-level architecture of the of the pluggable routing infrastructure with details around extension points as well as the flow of traffic through the system, suitable for use in implementing the embodiments of the invention;

FIG. 2 provides an exemplary logical order of the module execution. While this logical order is suggested, this invention focusses on the overall architecture of making this as well as other orders possible;

FIG. 3 is a screenshot of an exemplary usage of the system from the point of view of an unsophisticated user as generated with the embodiments described herein;

FIG. 4 provides an enlarged view/structure of a module in accordance with the embodiments of the invention;

FIG. 5 provides an exemplary usage of the system by the regular audience which includes human as well as computer software, bots, other machines or tools. This describes the structure in which the embodiments of the invention may be consumed.

### DETAILED DESCRIPTION

The subject matter of the invention is described here with specificity to meet the statutory requirements. In no way, does this description intent to limit the scope of the invention or the claims to the description provided herein. Instead, the inventor contemplates the architecture can be modified slightly and used in different ways, in steps or in conjunction with other tools and technologies that are available presently or may be developed in the future. The “steps” or “modules” mentioned in the description are in not meant to described clear boundaries and an order is not implied unless specifically stated. The blocks and steps should not be treated as hard limits in general but can be re-arranged, merged or omitted.

Routing is typically the concept of traffic control where a set of rules are defined for traffic and by following those rules every entity within traffic can go to the correct destination as configured in the system. The traffic entities can include but are not limited to electric currents or signals or logical entities like data, payloads, messages, information fragments.

Such entities are in transit or motion which can be but is not limited to actual logical motion, or general flow.

Generally, routing involves a control center where all the traffic is received and from there a direction to the desired destination. In the router, traffic can be analyzed for the routing decision based on its content/payload as well as additional information like metadata, headers along with being logically lumped into groups with a state that is managed by the system for more efficient routing. While the traffic contains enough information to decide its fate, additional information can be sought out from similar traffic, past records, or from the sender or intended receiver by additional requests.

Routing generally is managed by a set of rules in a monolithic design where the ruleset or guide is fixed at the creation of the infrastructure where additional rules of the same type can be appended by the administrator at any time, new rule types and procedures normally involve ripping out of the old set and incorporation of the new ones by a patch, a framework or firmware update or a rulebook change. The rule data may be retained across launches or may be discarded based on the differences between the new and the old version. Generally, the rules are designed by an expert but with little insight into the actual usage by the end user. A sophisticated user is given small amounts of freedom to tweak the routing infrastructure, but the entire infrastructure is not pluggable and completely outside the control of the device owner. This limits the ability of the user from truly customizing the routing to clean up unwanted data and/or perform custom routing. Many users especially those in enterprise dealing with sensitive information resort to having a custom proxy server (which acts as the gateway to the internet where the control can be exerted) and the routing duties are delegated from the router to the proxy servers. Such a design is expensive to develop and maintain and delegating the routing responsibilities to a different machine cannot optimize routing performance as it adds a hop (one more gateway) before the internet can be reached.

Monolithic routing is very problematic in sensor networks used within internet of things where both the devices as well as the routers are a low memory and low CPU devices operated on a battery. Wastage of resources in the router which was not customized to the reporting needs can lead to a significantly shorter life of the entire network system. The reporting needs can change over time and a monolithic router is not capable of adjusting to the new needs. Either all possible reporting has to be built in or the router needs to be replaced to get additional data. Both the cases are expensive and less ideal. The parameters exposed by the routing system are not enough in the sensor networks where routers deal with changing requirements and a changing set of sensors based on the needs of the ever-changing landscape.

In accordance with the embodiments described herein, the inefficiencies caused by the monolithic router can be fixed by architecting change into the router so that it can respond better to the end user needs. The term “pluggable” as used throughout the description can be interpreted as having the capability to have changed to the routing logic through modules or components for the data transferred manually or through the network.

In some instances, these modules can be built into the router and be enabled or disabled based on user wishes. Here the user can be a human, an animal, a machine, an algorithm or any other entity that exerts control over the system. The control can be active or passive by the user providing changes manually or causing the changes by mere presence or through a side effect of some other activity in the network. A router can be defined as the system, the machine, the rulebook or any entity that exerts the controls the flow of traffic which could consist of physical, logical or energy flow between two points in space.

In some instances, modules can be supplied through updates to the hardware or software stack. These updates can be provided automatically based on a criterion or manually by a controller who determines needs for these additional modules to function. These modules can consist of but are not limited to physical parts like memory, processing units or sensors or can be completely built as logic that reaches the router transferred as data over means including but not limited to wires or through electromagnetic or light energy modes over a wireless medium.

In some instances, these modules could be independent entities that are not present within the same router but are instead logically intertwined with the device functionality and have connections to the router where the functionality can be operated. These modules can be split into parts that have both an onsite as well an offsite component both for the interplay between the router as well as with other devices which may be influencing the activity of the module.

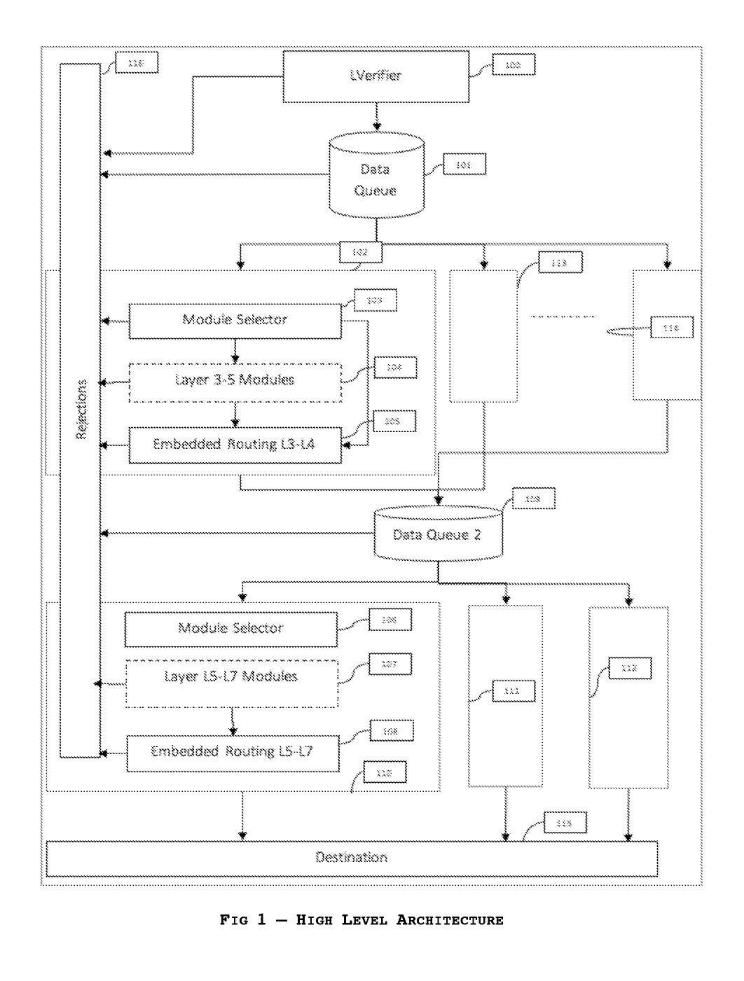

FIG. 1 illustrates a high-level architecture of the routing system where inputs are received at Connectivity Validator Module 100 which represents a connectivity validator. This module performs the physical reception of signals from the medium and may conform to the layer 1/layer 2 verification in the OSI network stack model. The module is not limited to the OSI network model but provides access and validation of traffic received for the inaccuracies due to the medium of transport for any type of traffic including but not limited to raw sensor data sent over in response to a beacon scheduled at regular intervals. This includes detection and isolation of traffic from other energy waves, radiations and other traffic like entities that enter the system but are not traffic that needs to be routed. Connectivity Validator Module 100 may be but is not limited to a single execution mode or a software thread and it can span to multiple instances all of which receive traffic in parallel (not shown in FIG. 1) and provide the filtered output to the data queue 101.

The rejections of stray entities that behave like traffic from this module are captured by OSI Layer L5-L7 embedded routing module 108 which is also responsible for capturing the rejections at all layers. This module provides a statistical mapping of interference and extraneous data as well as the efficiency estimates for the system from low level operating realities as present in Connectivity Validator Module 100 to higher level rejections as done by the plugged modules like Module Selector 103, OSI Layer L3-L4 Modules 104, Module Selector 106, OSI Layer L5-L7 Modules 107, OSI L3-L4 embedded routing module 105, and OSI L5-L7 embedded routing module 108.

The valid traffic entities are passed over to a first in first out data queue 101 which stores these for access by the processing threads 102, 113, 114 and others in parallel. This queue can be logical storage that can be but is not limited to volatile instance access memory like RAM, TCAM (ternary content-addressed memory) or registers, non-volatile quick access data sources like, NVRAM, flash (SSDs), ROM or magnetic drives. The queue has enough buffer capacity to store data as required in normal operation of the overall system and also has the capability to inform the Connectivity Validator Module 100 of overloads so that the module can tune the traffic sources to slow down the traffic and cache it until the congestion clears. It is also built with a selection of eviction policies configurable by the end user including but not limited to diversity retention, newest rejection, oldest rejection, and periodic rejection. In extreme circumstances of congestion, the data queue 101 can send traffic to Rejections 116 but that is not expected in normal operation.

The traffic is picked over in parallel by filtering entities who are running in multiple instances of processing Module 102, 113, 114 and so on and are responsible for routing traffic to the data queue 109. These instances share the rules and the series of modules that are run. These may also share memory for the rules and procedures, though the data may not be shared to ensure effective parallelization. This set consists of three component types Module Selector 103, Layer L3-L4 Modules 104 and L3-L4 embedded routing module 105. Processing Module 102 is functionally similar to Processing Module 110 and the differences between the two are provided in the ensuing text.

103 is the module selector which detects the list of modules that the user has selected for the routing and coordinates the passage of traffic through various user-defined plugins. This router is also responsible for enabling the debug mode and the bypass mode where the plugins may not be able to reject data, or the plugins may be bypassed. This does not reject packages or forward any of them to a destination but instead coordinates the flow of information through the various user-selected modules in Layer L3-L4 Modules 104. It provides the various API calls defined in FIG. 4 to the modules in Layer L3-L4 Modules 104.

Layer L3-L4 Modules 104 consists of modules selected by the user as plugins in the routing. The user can select two types of modules and based on their type they can either be present in Layer L3-L4 Modules 104 or in Layer L5-L7 Modules 107. It consists of modules that deal individually with the traffic units. In the OSI model, these include handling of OSI L3-L4 level data. In the case of other types of networks like IOT, Layer L3-L4 Modules 104 modules perform the task based on individual traffic/packet characteristics. These include but are not limited to tasks needed in the logical view 504, as defined for the individual use cases. These modules are present sequentially in the order defined by the type of the module and data access.

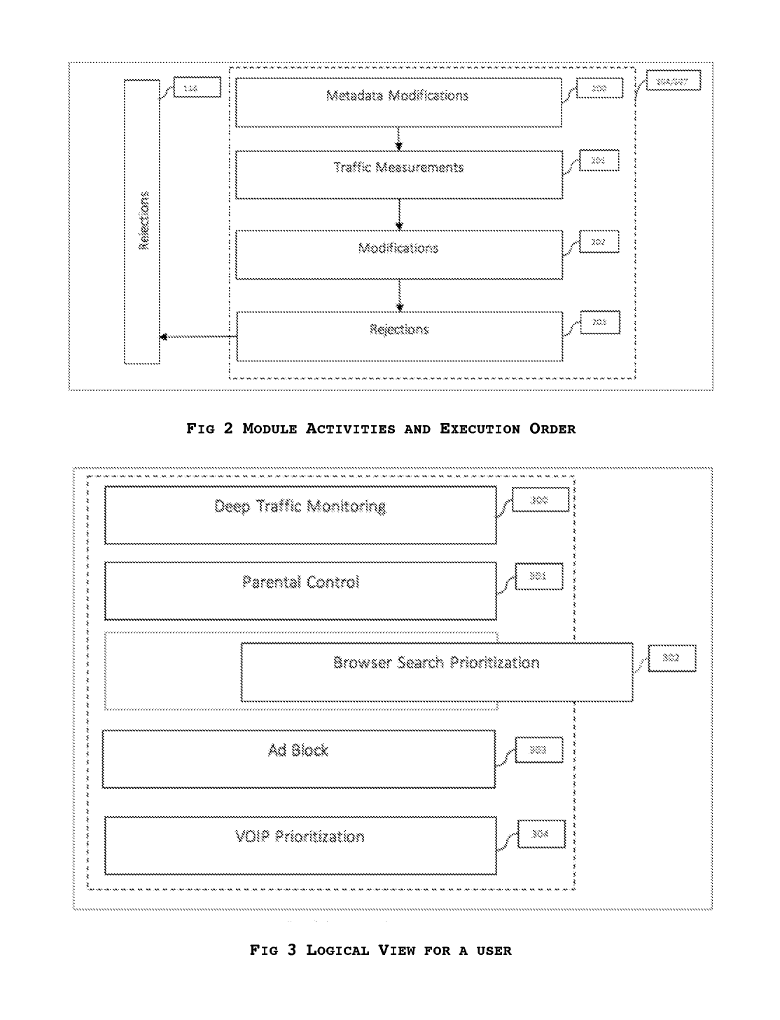

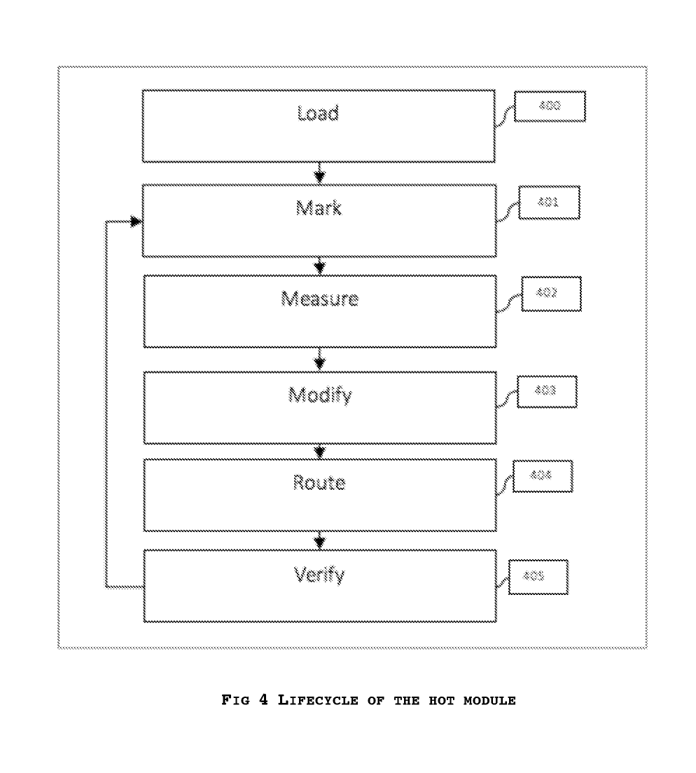

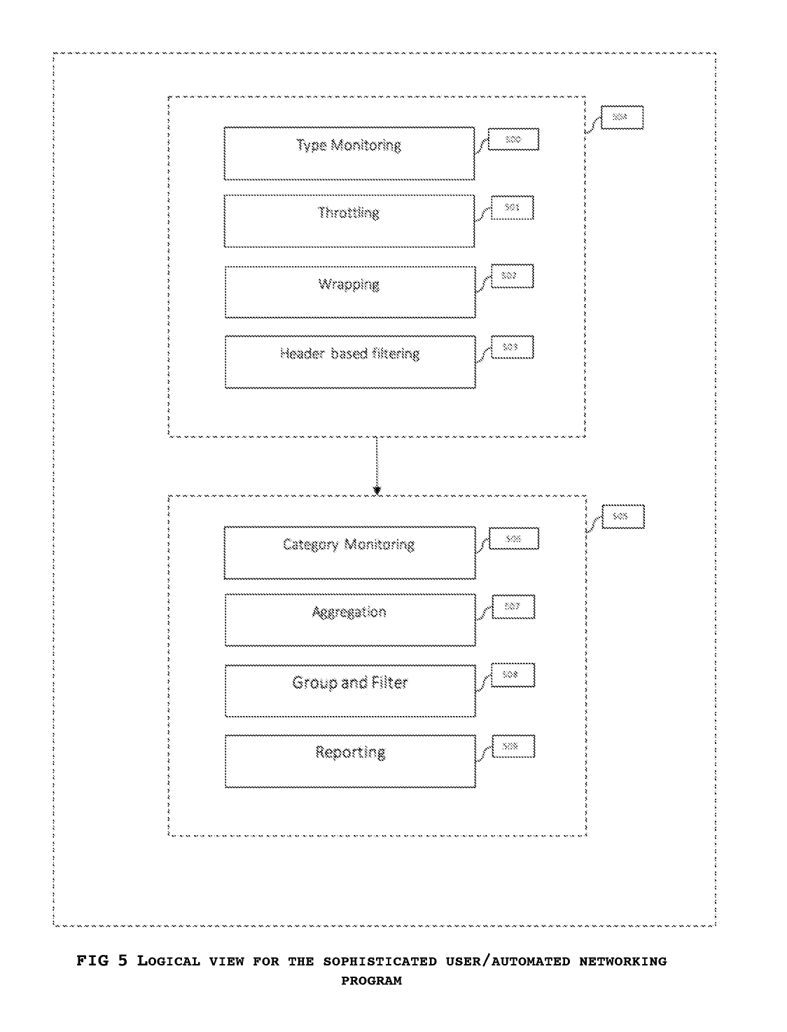

FIG. 2 defines the order of execution of the module activities for each module in Layer L3-L4 or Layer L5-L7 Modules 104/107. FIG. 4 defines the various stages of the module contract. Each module consists of one or more activities which can be one of Metadata Modification 200, Traffic Measurement 201, Modification 202 or Rejections 203. Activity Metadata Modification 200 appends additional information without modifying a traffic entity. They get access to the data and can append a priority, understand the traffic type and provide information about the destination, check for the known rejection rules and mark an item for deletion or even wrap the traffic in a wrapper information packet to masquerade it or send it to a different destination like a proxy server. The activities are not limited to those described herein but these activities are provided as an example of the type of activities an individual traffic entity level metadata Modification, Metadata Modification 200 can perform. Individual activities within the category numbered Metadata Modification 200 are ordered based on the logical order decided by the user for modules as per FIG. 3 and FIG. 5.

Activities with Traffic Measurement 201 are responsible for using the data provided by the activities in Metadata Modification 200 and read the information after all the metadata additions/updates have been performed. This provides for these activities to get accurate information that will not change during the entire operation of routing within the top-level layer Processing Module 102 or Processing Module 110. The activities in category Traffic Measurement 201 provide statistics and measurements on the ingested data and therefore. These cannot modify the module data or the metadata and are merely responsible for measurement and reporting. In some instances, these measurements may be passed over as is while in some other these may be modified for reporting. In some instances, these measurements may be grouped/aligned with the measurements in the Traffic Measurement 201 category activities from Processing Module 110 layer as well. In some instances, dedicated measurements within 115 and Rejections 116 are also taken into consideration for reporting activities.

Activity Modification 202 may modify the module data as well as the metadata. These involve error checking/fixing, adding missing information to the core module data so that it can help with the actual route determination in Rejections 203.

Activity Rejection 203 categories are responsible for the actual routing of the traffic for the level Processing Module 102/Processing Module 110. The actual routing involves passing the traffic to the next stage or rejecting the traffic and sending it over to Rejections 116. The passed traffic goes through a series or Rejections 203 in the order defined by the user as per FIG. 3 and FIG. 5 until it is either rejected or passed on. Once the traffic goes through all the Rejections described in all the modules, it has crossed from Layer L3-L4 or Layer L5-L7 Modules 104/107 to L3-L4 or L5-L7 embedded routing module 105/108.

The exposed contract of a module consists of stages as described in FIG. 4. Each module within Layer L3-L4 or Layer L5-L7 Modules 104/107 may expose one or more of the contact points for the various stages in FIG. 4. Stage Load 400 is called once when the module goes into execution where it gets the ability to initialize its state, get the user configuration, the options, and the history. Stage Mark 401, Measure 402, Modify 403 and Route 404 coincide with activities Metadata Modification 200, Traffic Measurement 201, Modification 202 and Rejections 203 respectively. Note that while the traffic flows through activities in order, the modules may get any call for any activity of any traffic entity. The state of a traffic is to be recorded in metadata within the traffic on stage Mark 401. Then the measurements are recorded in Measure 402 and the traffic is modified in Modify 403. In Route 404 the module decides whether to send the traffic to Rejections 116.

For traffic not passed on to Rejections 116, the module gets a chance to update its measurements in Verify 405. Each module has to register interest in a traffic entity in Mark 401 for Verify 405 to be provided with that traffic entity once the entire process is complete. All the traffic that the module does not decide to send to Rejections 116, the module gets a call from 115 or Rejections 116 to verify the state and update the measurements with the eventual outcome of the routing. In stages Verify 405 the module only has read-only access to the traffic entity and cannot change the traffic, its metadata or the destination. It can only record and update the own heuristic/cache of the module based on the eventual outcome for the traffic. Most of the reporting/alarming functionality is based on stage Verify 405 in the module.

After Layer L3-L4 Modules 104, the traffic goes to Layer L3-L4 embedded routing module 105 the default fallback router. In the diagnosis modes, the traffic can directly be sent to L3-L4 embedded routing module 105 from Module Selector 103. The module consists of the default sanity rules to ensure basic functionality. It also performs the responsibility for updating the metadata for the traffic that is not catered to be any modules in Layer L3-L4 Modules 104. The rules of the module mostly baked in with settings exposed to the end user. It is extremely lightweight and does not perform any major routing just ensures that traffic that got missed by all the modules in Layer L3-L4 Modules 104 finds its proper place in 109.

109 is a grouping data queue. It is different from data queue 101 in the sense that it groups individual traffic entities based on the metadata provided by Metadata Modification 200 or 105 and provides access to the aggregate or group for the access from Processing Module 110, 111, 112 and so on. It forms a prioritized queue based on the priority defined in the metadata and the higher priority traffic is first picked up. The output roughly coincides with OSI layers L5, L6, and L7 data, but it is not limited to the OSI model in any sense. It can include logical groupings based on the metadata present with the traffic. The traffic item can be grouped into multiple groups based on this metadata both a reference and as a copy as described when the metadata is set. This can be used in non-OSI models like sensor networks for tasks like aggregation and grouping. The modules present in Processing Module 110 can update the group by replacing all the data entries with a different one that provides the same information via compression or aggregation in case only an aggregate is needed. This can significantly improve the routing performance and traffic filtering. 109 also has a selection of eviction policies that can send the traffic to Rejections 116. The eviction policies in 109 are based on the metadata present in the traffic and it can focus on eviction based on the staleness of non-sequential data packets like UDP datagrams or low priority sensor readings. It can decide to thin groups where state need not be carried through traffic or can evict entire groups if they are of low importance as defined by the metadata in the Processing Module 102 processing.

After 109, the data carries optionally through Processing Module 110, 111, 112 and other instances in parallel. The pieces are optional in this invention and the absence of such pieces is also valid. Structurally each of these is exactly similar to Processing Module 102 described above. The major differences are that these items deal in groups of traffic rather than individual traffic entities. Module Selector 106 passes the pointer to an individual group within 109 to a module 107 which goes through the same stages as defined in FIG. 4 performing the activities in FIG. 2. The activities all happen in a group together and individual traffic entities share the metadata that belongs to the group. There are group level priorities, filtration method, and metadata. In the activity, Modification 202 the module can modify the group performing filtering and aggregating individual traffic entities. In all other states, the effects are applied to the entire group. The group may consist of one or more traffic entities and in certain cases like those where the group is of one traffic entity the entire structure Processing Module 110 might just bypass the data to 115. The state of individual traffic entities is shared via the group parameters and is used to determine the destination as well as the throttling, thinning, aggregation and filtering tasks. Discarded traffic items individually pass into Rejections 116 while merged items go into 115 along with unmodified traffic entities. The L5-L7 embedded routing module 108 is responsible for fallback routing for mixed groups with parameters for fallback Quality of Service and congestion control on the final destination route based on the priority in the individual packets.

Both 115 and Rejections 116 provide one final read-only access to the traffic and its metadata through Verify 405 to all the modules. This was the measurements can be accurate and the modules quantify the depth of their activity as well as the impact of their changes heuristically ignoring packets in other phases if some higher order module is impacting their output.

FIG. 3 presents an exemplary usage and control system for a non-sophisticated end user as in the case of IOT applications or enterprise traffic control. It shows a set application-level plugin, for example, Deep Traffic Monitoring 300, parental control 301, browser search prioritization 302, Adblock 303, and VOIP prioritization 304. Numerous such plugins can be developed by the application developers. All the plugins are executed sequentially in process or thread while there is process or thread pool of such executing units running in parallel.

Such users may be exposed to the more complicated but powerful system in FIG. 5 in an advanced mode. In this system, the logical layer gives a soft order of execution to modules and the user is not burdened with the complexities involved with the separation of Processing Module 102 and Processing Module 110 series. The user provides the priority of execution and the Module Selector 103 and Module Selector 106, pick individual modules based on the user defined priority. The prioritization is soft, and the modules may define overrides as well as handle API calls in both the modes executing as Layer L3-L4 or Layer L5-L7 Modules 104 and 107.

FIG. 5 represents a more sophisticated view of a system with defined separate areas picked up Module Selector 103 and Module Selector 106. This case is used for sensor network systems where the router modules can be configured based on the requirements and the modules can be added or removed based on what is desired. 504 and 505 define two separate areas for traffic entity and traffic group related modules or packages that are controlled by the administrator or the control chip of the system. The individual modules are ordered and can still have components in both Processing Module 102 and Processing Module 110, but the control system has access to the primary activity of the module and the module is written for fine-grained activity in any one of the layers. It is desired but not required to have individual modules for individual activity so that they can turn off and tuned one by one. The data structure present in the traffic metadata is shared and therefore the schema or format of that is publicized and shared with module developers who adhere strictly to the defined standard. This standard is beyond the scope of this invention. It may be based on the OSI headers, packet type or custom blocks of data represented in any binary or text-based format. Typical modules in this system are shown as Type Monitoring 500, Throttling 501, Wrapping 502 and Header based filtering 503 for Processing Module 102 and Category Monitoring 506, Aggregation 507, Group and Filter 508 and Reporting 509 for Processing Module 110 respectively. The former set of modules perform tasks Metadata Modification 200, Traffic Measurement 201, Modification 202 and Rejections 203 at the individual traffic entity level while the latter set deals with the group level. The control system (outside of the figures) can decide based on the reporting by these modules and the requirements to select the modules and the module order needed herein.

As can be understood, the embodiments of the current invention point to a system of providing pluggable components or modules to enable customizable routing where the control is exposed to the end user/control unit to logically decide the order of execution, the content and the characteristics of the module that perform the routing in the protected environment with fallbacks in place for handling default routing and forwarding of information in case a plugin is not present for certain types of traffic.

We claim:

1. The architecture to provide low latency and low overhead routing platform that supports running user-controlled pluggable components for with the capabilities
1.1. Splitting of routing plugins into two categories the individual and group level routing as well as the flow of traffic via control structure present in queues both at individual and group level. After the Layer 1 and Layer 2 Verification, the system maintains two separate Data Queues, two separate Modules types, two Selectors, and two routing engines.
1.2. The logical abstraction for an advanced user or a control system to be able to handle inputs from the measurement reports and exert maximum control on the system using different individual and group level module

2. The architecture of network infrastructure and application/user-controlled transport layer routing platform abstraction that supports
2.1. routing process consisting of activities that are performed in the execution order of Metadata modification, Traffic Measurement, Modification, and Rejections in order to enable maximal control via plugins.
2.2. caching, proxying, firewalling and alternate routing at the application layer.
2.3. controlling the OSI layer 3+ functionality from the application layer with protocol specific application control.

3. The logical abstraction of the routing plugin structure for an unsophisticated use and the mechanism to simplify the routing process for manual control on the system.
3.1. User-controlled pluggable components capable of Real-time mediation and overridable transmission and reception of data packets to and from an external network providing fine-grained control to the routing internals such as QoS, encryption/anonymization, DNS overrides, firewalling, and packet analysis.
3.2. The structure of a routing module and the integration or hook points that are used to provide access to control for various routing activities.
